(19) United States
(12) Patent Application Publication
(10) Pub. No.: US 2005/0108274 A1
(43) Pub. Date: May 19, 2005

(54) System and method for web server synchronization

(76) Inventors: Daniel Selman, Gentilly Cedex (FR); Robert Bergman, Denver, CO (US); Edward K. O'Neil, Boulder, CO (US)

Correspondence Address: FLIESLER MEYER, LLP, FOUR EMBARCADERO CENTER, SUITE 400, SAN FRANCISCO, CA, 94111, US

(21) Appl. No.: 10/787,707

(22) Filed: Feb. 26, 2004

Related U.S. Application Data
(60) Provisional application No. 60/449,952, filed on Feb. 26, 2003.

(51) Int. Cl. G06F 17/00

(52) U.S. Cl. 707/102

(57) ABSTRACT

A system and method for propagating information, comprising accepting the information in a first enterprise application; updating a first repository based on the information, wherein the first repository is persistent; updating a second repository based on the information; notifying at least one subscriber repository of the information; and synchronizing the at least one subscriber repository with the second repository.

### CLAIM OF PRIORITY

This application claims priority from the following application, which is hereby incorporated by reference in its entirety:

SYSTEM AND METHOD FOR WEB SERVER SYNCHRONIZATION, U.S. Application No. 60/449,952, Inventors: David Landers, et al., filed on Feb. 26, 2003 (Attorney's Docket No. BEAS-1376US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BRIEF DESCRIPTIONS OF THE DRAWINGS

FIG. 1 illustrates a conceptual diagram of a system for creating and versioning application data files in accordance with an embodiment of the present invention.

FIG. 2 illustrates a high level block diagram of a system for synchronizing data in accordance with an embodiment of the present invention.

FIG. 3 illustrates a block diagram of a server running an enterprise application having data that can be synchronized in accordance with an embodiment of the present invention.

FIG. 4 is a flowchart illustrating a process for synchronizing data in accordance with an embodiment of the present invention.

FIG. 5 illustrates a block diagram of multiple servers running enterprise applications with data that can be synchronized using a proxy data repository in accordance with an embodiment of the present invention.

FIG. 6 illustrates a block diagram of a cluster of servers running enterprise applications with data that can be synchronized by an administration server in accordance with an embodiment of the present invention.

### DETAILED DESCRIPTION OF THE INVENTION

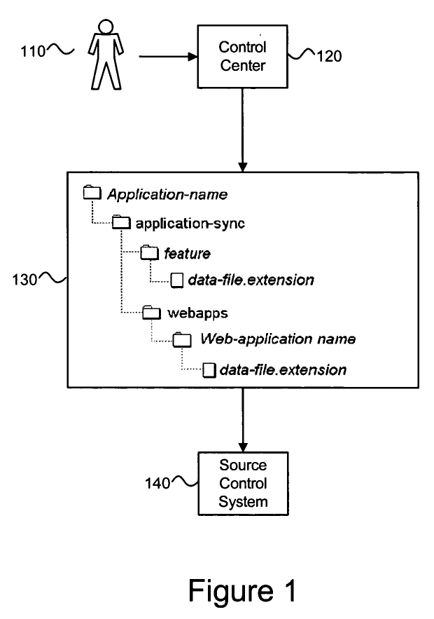

FIG. 1 illustrates a conceptual diagram of a system for creating and versioning application data files in accordance with an embodiment of the present invention. Author 110 is a person with the responsibility of creating application data to be used by one or more web applications and/or services. In various embodiments, author 110 can be a line-of-business manager, business engineer, developer, or other person responsible for authoring application data. The application data can be used to configure a web application to operate in accordance with business logic identified by author 110. For example, application data created by author 110 can include business policy documents such as campaign definitions, scenarios, business rule sets, portal definitions, and/or other types of data used by web applications.

In order to produce the application data, author 110 can interface with various software tools, such as control center 120. In one embodiment, control center 120 is an E-Business Control Center tool available from BEA Systems, Inc. of San Jose, Calif. The data created by author 110 using control center 120 can be stored in a local hierarchical file system as a set of application data files. FIG. 1 illustrates an example of application data files 130 stored in a hierarchical file system. The application data files 130 can be organized according to the web application they are created for. In one embodiment, the application data created with control center 120 is stored in XML files in accordance with an XML schema which can be interpreted by the web application for which the data is authored. Since XML can be read and interpreted by various systems across multiple platforms, the use of XML application data provides advantages over database scripting-oriented approaches.

Application data files 130 produced by the interaction of author 110 with control center 120 can be checked into source control system 140. Source control system 140 allows different versions of the application data files 130 to be easily recalled for testing, deployment, synchronization, and/or other purposes. For example, if faulty application data is deployed to a web application, the source control system 140 allows author 110 to recall a previous version of the application data and re-deploy the data to the web application. The use of source control system 140 can also prevent multiple authors from overwriting each other's files when application data is being authored concurrently. In one embodiment, source control system 140 is any suitable source control system known in the art.

After application data has been created, it will typically be subject to a multi-stage approval process to test the interaction of the newly-authored application data with other data and/or applications created by other authors. For example, before application data is deployed to a production server, it may be subject to separate development and quality assurance stages. These stages help ensure that the web applications running on live production servers will operate reliably.

During this collaborative development of web applications, it can become desirable for software developers to synchronize application data across enterprise application boundaries to remote servers. Various data synchronization processes further described herein leverage the advantages provided by HTTP to facilitate the synchronization of application data on remote servers accessible via the Internet. In accordance with certain embodiments of the present invention, newly-created application data can be synchronized with one or more remote running servers. By identifying the URL associated with a server, application data can be remotely synchronized to any server accessible over the Internet via HTTP.

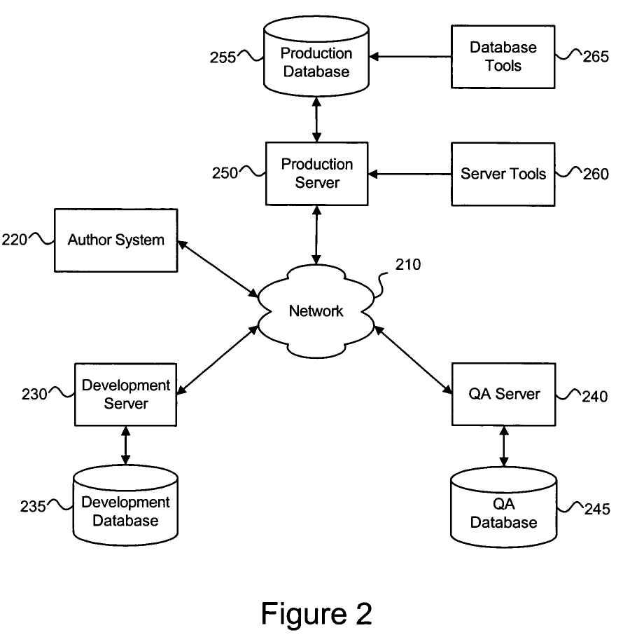

FIG. 2 illustrates a high level block diagram of a system for synchronizing data in accordance with an embodiment of the present invention. The system of FIG. 2 can be used for collaboratively developing and testing web applications before they are ultimately deployed on a production server. In one embodiment, the system of FIG. 2 is implemented using one or more components of BEA WebLogic Platform™, available from BEA Systems, Inc. of San Jose, Calif. As illustrated in FIG. 2, a plurality of servers are in communication with network 210. In one embodiment, the system of FIG. 2 is implemented as a peer-to-peer network. Each server of FIG. 2 is associated with a database which can store application data used by web applications and/or services running on the server. As indicated by FIG. 2, each server can be used for a different purpose in a multi-stage application data approval process. For example, these purposes can include: development (server 230 and database 235), quality assurance (server 240 and database 245), production (server 250 and database 255), and others (not shown).

Each server of FIG. 2 is capable of receiving application data from author system 220 over network 210. The application data received from author system 220 can be synchronized with application data used by web applications running on the various servers as further described herein. In one embodiment, author system 220 is the system illustrated in FIG. 1.

Server tools 260 and database tools 265 are also illustrated in FIG. 2. These tools allow for the realtime modification of data on production server 250 and production database 255, respectively. In one embodiment, server tools 260 are JSP-based tools which allow changes to be made directly to production server 250.

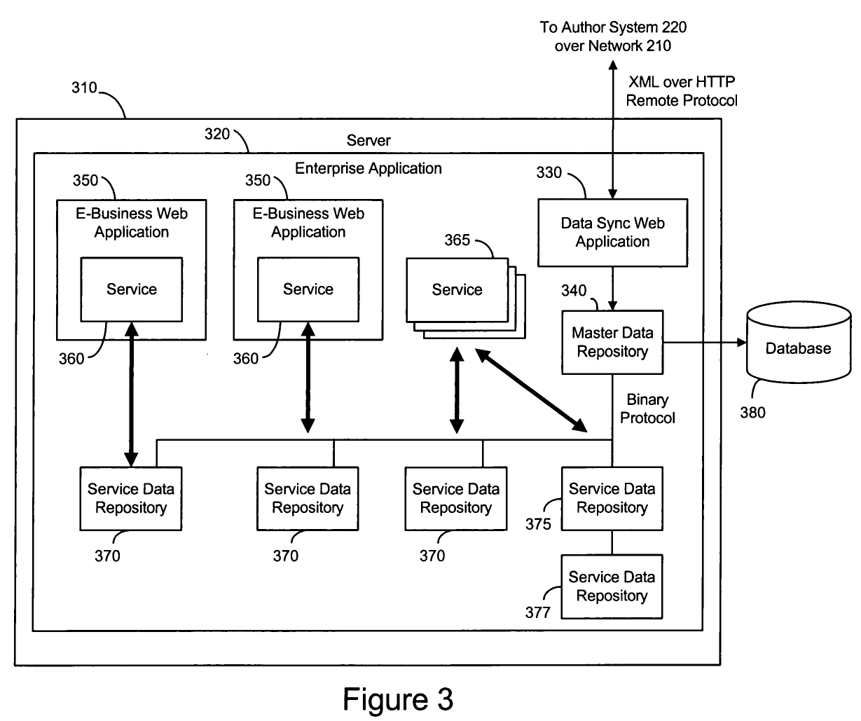

FIG. 3 illustrates a block diagram of a server running an enterprise application having data that can be synchronized in accordance with an embodiment of the present invention. Server 310 can be any of the servers illustrated in FIG. 2 capable of receiving application data from author system 220. As illustrated in FIG. 3, a plurality of web applications and services reside in enterprise application 320 running on server 310. E-business web applications 350 include services 360 that rely upon application data stored in service data repositories 370, 375, and/or 377. Additional services 365 running within the context of enterprise application 320 can also rely upon application data stored in the service data repositories. In one embodiment, the service data repositories are Java objects that function as in-memory caches of data items of interest to a deployed class of service.

Data sync web application 330 also runs within enterprise application 320 and is responsible for performing data synchronization operations in accordance with the present invention. As indicated by FIG. 3, data sync application 330 can communicate with author system 220 of FIG. 2 over network 210. A master data repository 340 within enterprise application 320 can communicate with data sync application 330, database 380, and data repositories 370 and 375.

Data sync application 330 can intercept incoming synchronization requests sent from author system 220 over network 210. In one embodiment, these synchronization requests are sent as XML over HTTP in accordance with a remote protocol. When data sync application 330 receives a synchronization request from author system 220, it channels application data received from author system 220 to master data repository 340 which is a runtime representation of the application data. The data sync application 330 also channels the application data received to database 380 which is a persistent storage location for the application data. In one embodiment, data repository 340 stores incoming application data as Enterprise Java Beans (EJBs). In another embodiment, database 380 is a relational database management system.

In one embodiment, data sync application 330 includes a set of JSPs that are capable of reporting: the contents of master data repository 340, data repositories that are successfully synchronized with master data repository 340, and the contents of each data repository in enterprise application 320.

The service data repositories of FIG. 3 each contain subsets of the application data stored in master data repository 340. Services 360 and 365 use the data in the service data repositories to carry out business tasks. For example, a rules service can use the data to evaluate whether customers fit into a particular customer segment. Since the service data repositories of FIG. 3 maintain only a subset of the data in master data repository 340, each service is able to parse a small, specific set of application data needed by the service without having to maintain copies of all application data maintained in master data repository 340.

Each time the master data repository 340 is synchronized, it notifies data repositories 370 and 375. These data repositories then synchronize their data subsets with the data in the master. In one embodiment, application data is communicated between the components of enterprise application 320 in accordance with a binary protocol. Multiple enterprise applications (not shown) running on server 310 can also be synchronized using a separate data sync application running in each enterprise application. Proxy data repositories can be used to facilitate such synchronizations.

In some cases, the master data repository 340 does not directly synchronize data with a data repository. Rather, a notification chain can be employed using multiple data repositories. Referring to FIG. 3, data repositories 375 and 377 form a notification chain. When data repository 375 receives updated application data from master data repository 340, it notifies data repository 377. Data repository 377 can then be synchronized with the application data received by data repository 375. As a result, both repositories 375 and 377 can be synchronized without master data repository 340 having to send updated application data to both repositories.

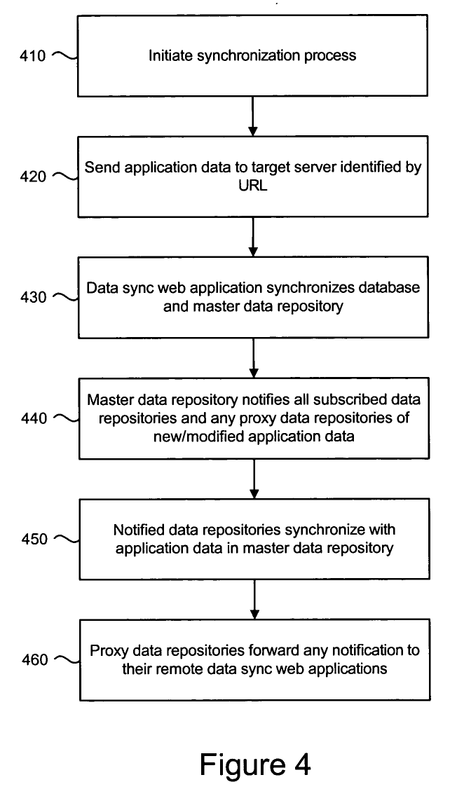

FIG. 4 is a flowchart illustrating a process for synchronizing data in accordance with an embodiment of the present invention. When application data is to be synchronized from author system 220 to any of the servers of FIG. 2, a synchronization process can be initiated (step 410) by sending a synchronization request from author system 220 to the URL of the server to be synchronized where it will be intercepted by data sync application 330. In various embodiments, author 110 can initiate the synchronization process using a graphical interface of control center 120 or a Java command line.

In various embodiments of the present invention, different synchronization modes can be employed. In a refresh-from-client mode, all application data for a given application is synchronized. Using this mode, all data is cleared from the data repositories and then all relevant application data files are sent from the author's local file system to a data sync web application. This mode can be helpful to synchronize in-memory data with persisted data, or to recover from a synchronization error. In a one-way-from-client mode, only those application data files that have been removed, updated, or created on the author's local file are updated. Thus, the amount of data transmitted between an author system and a server to be synchronized can be minimized.

Upon initiation of the synchronization process in step 410, application data to be synchronized will be sent from author system 220 to server 310 over network 210 (step 420). In one embodiment, the application data is sent as XML files over HTTP using a POST command. The application data is received by data sync application 330. Data sync application 330 then synchronizes database 380 and master data repository 340 with the newly-received application data (step 430). As a result of step 430, database 380 contains the updated application data stored in a database format for persistent storage, and master data repository 340 contains the updated application data stored in an EJB runtime format.

As previously described herein, the various applications and services of FIG. 3 may rely upon application data resident in service data repositories. Accordingly, each of the service data repositories can subscribe to receive updated application data. In order to update the application data in data repositories 370 and 375, master data repository 340 notifies each of service data repositories 370 and 375 of any updated application data for which the repositories have subscribed to receive (step 440). Service data repository 377 receives its notification via a notification chain, as previously described. Master data repository 340 also notifies proxy data repositories (not shown) for enterprise applications running on other servers, as further described herein. After the service data repositories have been notified of the updated application data, each repository synchronizes itself with the particular application data in master data repository 340 to which it subscribes (step 450). Proxy data repositories also forward any notifications sent in step 440 to their remote data sync web applications in order to synchronize repositories running in other enterprise applications (not shown) on server 310 or other remote servers (step 460), as further described herein.

Service data repositories 370 and/or 375 can also poll master data repository 340 periodically to check whether application data has been updated. If updated data is detected, then application data maintained in master data repository 340 can be synchronized with service data repositories 370 and/or 375.

Master data repository 340 maintains a log that describes each update and includes a description of which data repositories were successfully updated, and which were not. Data sync application 330 can return a status message to author system 220 via HTTP or a Java command shell to identify which application data files were successfully synchronized. Each data repository of FIG. 3 can also maintain logs that describe its current contents.

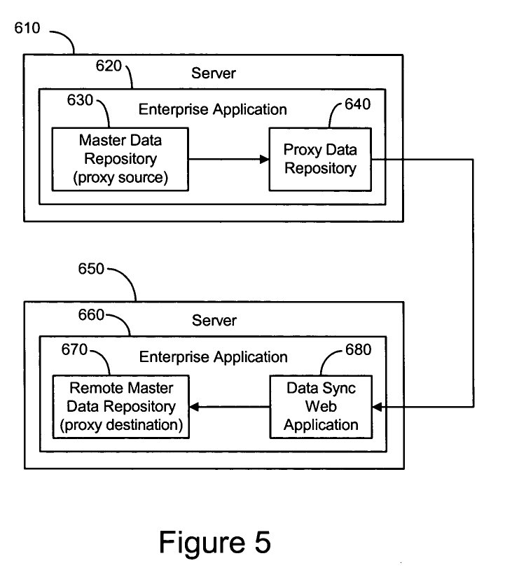

As illustrated in FIG. 3, application data can be synchronized between an author system and an enterprise application running on a single server. In accordance with various embodiments of the present invention, multiple servers can also synchronized through a single synchronization process initiated in step 410 of FIG. 4. This synchronization of multiple servers can be facilitated through the use of additional elements as set forth in FIG. 5.

FIG. 5 illustrates a block diagram of multiple servers running enterprise applications with data that can be synchronized using a proxy data repository in accordance with an embodiment of the present invention. Enterprise applications 620 and 660 are running on servers 610 and 650, respectively. A master data repository 630 running within enterprise application 620 can be synchronized by a data sync application (not shown) in communication with an author system (not shown) as previously described herein. Master data repository 630 is in communication with proxy data repository 640 also running within enterprise application 620. Proxy data repository 640 can subscribe to receive updated application data stored in master data repository 630.

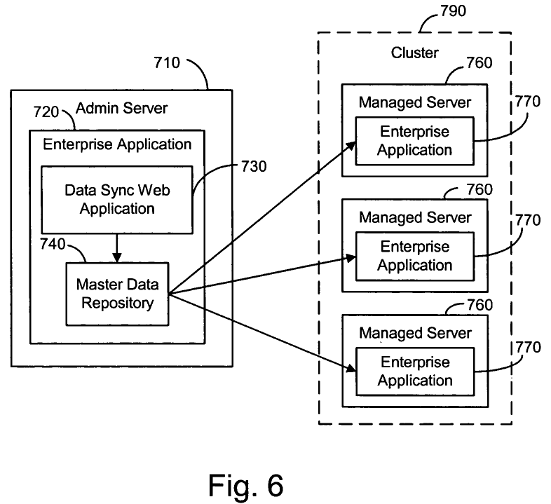

Data sync web application 680 is an instance of a data sync application that runs on remote server 650. However, rather than receiving updates directly from an author system 220 (similar to data sync application 330 of FIG. 3), data sync application 680 receives updates sent from proxy data repository 640. Remote master data repository 670 is a master data repository for enterprise application 660 which is updated in accordance with application data received by data sync application 680. Remote master data repository 670 can pass updated application data to other proxy and/or service data repositories (not shown) running in enterprise application 660 as previously discussed herein. It will be understood that additional elements (not shown) can be present on the servers of FIG. 5, such as one or more of the elements set forth in the servers of FIG. 3 and/or FIG. 6.

In operation, master data repository 630 receives updated application data from a data sync web application in communication with an author system (not shown) such as author system 220 of FIG. 2. Proxy data repository 640 is subscribed to receive updated application data from master data repository 640. As a result, the updated application data received by master data repository 630 is passed to proxy data repository 640. Proxy data repository 640 then passes the application data from server 610 to the data sync application running on server 650. In one embodiment, application data is received by proxy data repository 640 in accordance with a binary protocol. Accordingly, proxy data repository 640 marshals the application data into an XML format before passing the application data as XML over HTTP to data sync application 680 in remote server 650.

When the updated application data is received by data sync application 680, it cam update remote master data repository 670 with the updated application data. A persistent storage database (not shown in FIG. 5) as illustrated in FIG. 3 is also synchronized, and the updated application data is then forwarded to all data repositories (not shown) of enterprise application 660 which are subscribed to receive the updated application data.

Thus, by subscribing proxy data repositories to receive updates from a master data repository, application data within enterprise applications running on remote servers can be synchronized with application data received by the master data repository. Proxies can also be used to synchronize data across different enterprise applications running on the same server. Moreover, by linking remote servers to additional remote servers through proxies, chains of multiple servers can be synchronized. These principles can be further applied to the synchronizing application data across clusters of servers as set forth in FIG. 6.

FIG. 6 illustrates a block diagram of a cluster of servers running enterprise applications with data that can be synchronized by an administration server in accordance with an embodiment of the present invention. Data sync web application 730 and master data repository 740 of enterprise application 720 on administration server 710 can communicate with managed servers 760 of cluster 790. As previously discussed, application data residing in data repositories (not shown) of enterprise applications 770 running on remote servers 760 can be synchronized with updated application data stored in master data repository 740. Master data repository 740 can pass updated application data to a proxy data repository (not shown) which then passes the data to data sync web applications (not shown) running on enterprise applications 770. As a result, multiple servers 760 can be synchronized by a single administration server 710 that receives updated application data from an author system (not shown). It will be understood that additional elements (not shown) can be present on the servers of FIG. 6, such as one or more of the elements set forth in the servers of FIG. 3 and/or FIG. 5.

Where applicable, the present invention can be implemented using hardware, software, or combinations of hardware and software. Software in accordance with the present invention, such as program code and/or data, can stored on one or more computer readable mediums. Also where applicable, the various hardware components and/or software components set forth herein can be combined into composite components comprising software, hardware, or both without departing from the spirit of the present invention. Similarly, where applicable, the various hardware components and/or software components set forth herein can be dissected into sub-components comprising software, hardware, or both without departing from the spirit of the present invention. In addition, where applicable, it is contemplated that software components can be implemented as hardware components, and vice-versa. Furthermore, where applicable, the various steps set forth herein can be combined into composite steps and/or dissected into sub-steps. It is also contemplated that software components set forth herein can be implemented using one or more general purpose or specific purpose computers and/or computer systems, networked and/or otherwise.

The foregoing disclosure is not intended to limit the present invention to the precise forms or particular fields of use disclosed. It is contemplated that various alternate embodiments and/or modifications to the present invention are possible in light of the disclosure.

1. A method for propagating information, comprising:
accepting the information in a first enterprise application;
updating a first repository based on the information, wherein the first repository is persistent;
updating a second repository based on the information;
notifying at least one subscriber repository of the information; and
synchronizing the at least one subscriber repository with the second repository.

2. The method of claim 1 wherein:
the information is in Extended Markup Language (XML) format.

3. The method of claim 1 wherein:
at least one of the at least one subscriber repositories can provide the information to another repository.

4. The method of claim 1 wherein:
at least one of the at least one subscriber repositories can act as a proxy and provide the information to a second enterprise application.

5. The method of claim 4, wherein:
the second enterprise application can update at least one third repository with the information.

6. The method of claim 5, wherein:
the at least one third repository can act as a proxy and provide the information to a third enterprise application.

7. The method of claim 1 wherein:
the first information contains only information that has changed.

8. The method of claim 1, further comprising:
registering the at least one subscriber repository to receive information notifications from the second repository.

9. The method of claim 1 wherein:
an enterprise application includes at least one of: 1) a web application; and 2) a web service.

10. The method of claim 1 wherein:
the second repository is on a different computing device from the at least one subscriber repository.

11. A method for propagating information, comprising:
accepting the information in a first enterprise application;
updating a first repository based on the information, wherein the first repository is persistent;
updating a second repository based on the information;
notifying at least one subscriber repository of the information;
synchronizing the at least one subscriber repository with the second repository; and
at least one of the at least one subscriber repositories can provide the information to another repository.

12. The method of claim 11 wherein:
the information is in Extended Markup Language (XML) format.

13. The method of claim 11 wherein:
at least one of the at least one subscriber repositories can act as a proxy and provide the information to a second enterprise application.

14. The method of claim 13, wherein:
the second enterprise application can update at least one third repository with the information.

15. The method of claim 14, wherein:
the at least one third repository can act as a proxy and provide the information to a third enterprise application.

16. The method of claim 11 wherein:
the first information contains only information that has changed.

17. The method of claim 11, further comprising:
registering the at least one subscriber repository to receive information notifications from the second repository.

18. The method of claim 11 wherein:
an enterprise application includes at least one of: 2) a web application; and 2) a web service.

19. The method of claim 11 wherein:
the second repository is on a different computing device from the at least one subscriber repository.

20. A machine readable medium having instructions stored thereon that when executed by a processor cause a system to:
accept information in a first enterprise application;
update a first repository based on the information, wherein the first repository is persistent;
update a second repository based on the information;
notify at least one subscriber repository of the information; and
synchronize the at least one subscriber repository with the second repository.

21. The machine readable medium of claim 20 wherein:
the information is in Extended Markup Language (XML) format.

22. The machine readable medium of claim 20 wherein:
at least one of the at least one subscriber repositories can provide the information to another repository.

23. The machine readable medium of claim 20 wherein:
at least one of the at least one subscriber repositories can act as a proxy and provide the information to a second enterprise application.

24. The machine readable medium of claim 23, wherein:
the second enterprise application can update at least one third repository with the information.

25. The machine readable medium of claim 24, wherein:
the at least one third repository can act as a proxy and provide the information to a third enterprise application.

26. The machine readable medium of claim 20 wherein:
the first information contains only information that has changed.

27. The machine readable medium of claim 20, further comprising instructions that when executed cause the system to:
registering the at least one subscriber repository to receive information notifications from the second repository.

28. The machine readable medium of claim 20 wherein:
an enterprise application includes at least one of: 3) a web application; and 2) a web service.

29. The machine readable medium of claim 20 wherein:
the second repository is on a different computing device from the at least one subscriber repository.

30. A system for propagating information, comprising:
an enterprise application operable to accept the information;
a first repository operable to be updated based on the information, wherein the first repository is persistent;
a second repository operable to be updated based on the information;
at least one subscriber repository operable to be notified of the information; and
wherein the at least one subscriber repository is synchronized with the second repository.

31. The system of claim 30 wherein:
the information is in Extended Markup Language (XML) format.

32. The system of claim 30 wherein:
at least one of the at least one subscriber repositories can provide the information to another repository.

33. The system of claim 30 wherein:
at least one of the at least one subscriber repositories can act as a proxy and provide the information to a second enterprise application.

34. The system of claim 33, wherein:
the second enterprise application can update at least one third repository with the information.

35. The system of claim 34 wherein:
the at least one third repository can act as a proxy and provide the information to a third enterprise application.

36. The system of claim 30 wherein:
the first information contains only information that has changed.

37. The system of claim 30 wherein:
the at least one subscriber repository is registered to receive information notifications from the second repository.

38. The system of claim 30 wherein:
an enterprise application includes at least one of: 4) a web application; and 2) a web service.

39. The system of claim 30 wherein:
the second repository is on a different computing device from the at least one subscriber repository.
